(19) United States
(12) Patent Application Publication
(10) Pub. No.: US 2004/0057241 A1
(43) Pub. Date: Mar. 25, 2004

(54) Safety warning and winker light for vehicle

(76) Inventor: Yung-Fa Lin, Panchiao City (TW)

Correspondence Address: RABIN & BERDO, P.C., Suite 500, 1101 14 Street, N.W., Washington, DC, 20005, US

(21) Appl. No.: 10/247,692

(22) Filed: Sep. 20, 2002

(51) Int. Cl. B60Q 1/26

(52) U.S. Cl. 362/487; 362/493; 340/468

(57) ABSTRACT

A safety warning and winker light for vehicle includes a soft illuminative sheet and a high-adhesive sticker. The soft illuminative sheet having a plurality of illuminators is disposed on front windscreens of cars by the high-adhesive sticker on the bottom side thereof. Thus the present invention provides obvious warning effect for the cars approaching from the opposite direction.

### BACKGROUND OF THE INVENTION

1. Field of the Invention

The present invention relates to safety warning and winker light for vehicle, more particularly, to a safety warning light having a soft illuminative sheet and a high-adhesive sticker that is disposed on two lateral sides of front windscreens of cars so as to remind cars approaching from opposite side of roads.

2. Description of the Prior Art

At evening, there is still some light in surrounding. Most drivers don't turn on the headlights or lights at four corners. In the urban straight roads, there is no trouble. But in mountain area where the roads are narrow and winding, it is harder for drivers to see other vehicles due to insufficient light thus the probability of car accidents is raised.

Moreover, the turn signals and hazard flashers disposed on four corners can give cars from opposite direction warning. But on lateral sides of cars, there is no other signal for warning.

In the foggy or gloomy day, drivers' vision is easy to get impaired. When the headlights are turned on for warning upcoming cars on the opposite driveway, the vision of drivers is getting worse due to the reflection. Thus the fog lamp with yellow light is used to provide warning. But the effect is just adequate.

### SUMMARY OF THE INVENTION

It is therefore a primary object of the present invention to provide a safety warning and winker light for vehicle includes a soft illuminative sheet and a high-adhesive sticker. The soft illuminative sheet having a plurality of illuminators is disposed on front windscreens of cars by the high-adhesive sticker on the bottom side thereof so as to provide obvious warning effect for the cars approaching from the opposite direction.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 shows a perspective view of the present invention;

FIG. 2 is a schematic drawing showing the present invention being arranged on a front windscreen of a car;

FIG. 3 is an embodiment of the present invention;

FIG. 4 is a sectional view of another embodiment of the present invention;

FIG. 5 is a sectional view of a further embodiment of the present invention;

FIG. 6 is a sectional view of a further embodiment of the present invention.

### DETAILED DESCRIPTION OF THE PREFERRED EMBODIMENT

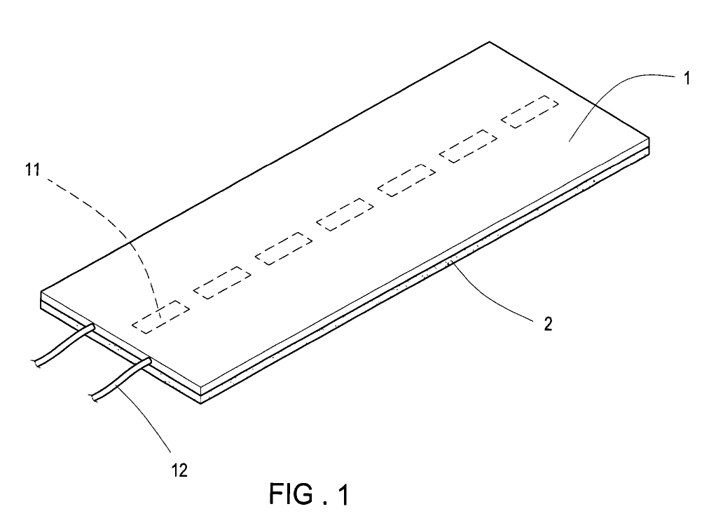

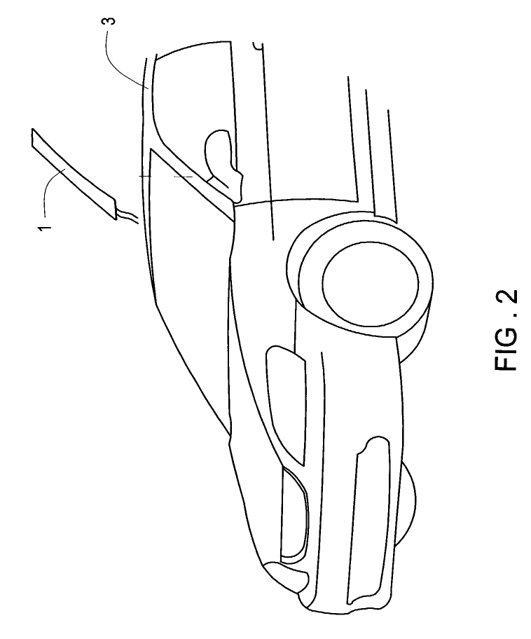

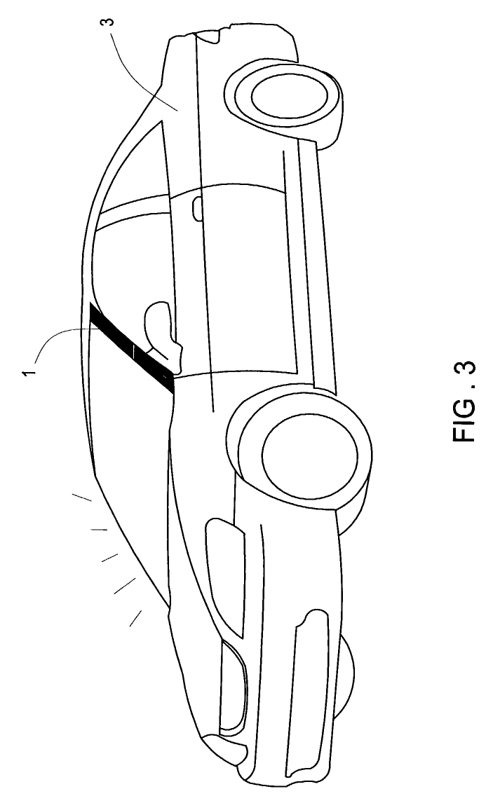

Refer to FIG. 1, FIG. 2 & FIG. 3, the present invention mainly includes a soft illuminative sheet 1 and a high-adhesive sticker 2. The soft illuminative sheet 1 having a plurality of illuminators 11 is connected with the power (not shown in figure) of cars 3 by a lead wire 12 so as to make illuminators radiant.

The high-adhesive sticker 2 is arranged on the bottom side of the soft illuminative sheet 1 for adhering the soft illuminative sheet 1 onto two lateral sides of a front windscreen of cars 3.

In accordance with the structure mentioned above, the soft illuminative sheet 1 is attached on the two lateral sides of the front windscreen of cars 3 by the high-adhesive sticker 2 for warning cars approaching from the opposite direction.

The soft illuminative sheet 1 can be designed to various kind of shape for matching different car models according to users' need.

Furthermore, the soft illuminative sheet 1 is not only used as warning signal but also is connected to control circuit of turn signal flashers so as to enhance hazard warning effect. This is another embodiment of the present invention.

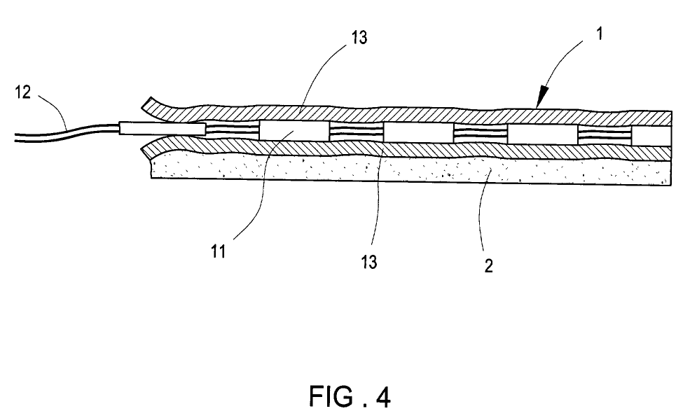

Refer to FIG. 4, the soft illuminative sheet 1 having two transparent sheets 13 with a plurality of illuminators 11 installed therebetween. This is an embodiment of the soft illuminative sheet 1.

The illuminators 11 can be light-emitting diode, diode chips or bulbs.

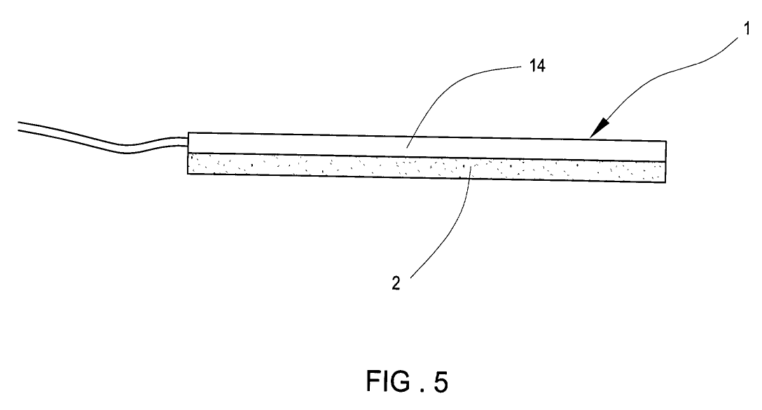

With reference of FIG. 5, the soft illuminative sheet 1 can be a cold light plate 14 that radiants in whole surface area so as to have better warning effect. This is a further embodiment of the present invention.

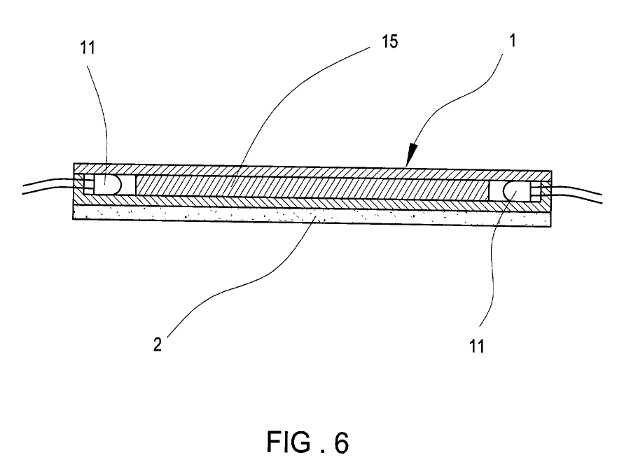

Refer to FIG. 6, the soft illuminative sheet 1 can be a plurality of light-guide bar 15. One or two illuminator 11 is disposed on one end or both two ends of the light-guide bar 15. The light emitted from the illuminator 11 passes through the light-guide bar 15 thus produce a plurality of light band. This is still a further embodiment of the present invention.

In addition, the illuminator 11 can emit different colors of light so as to make the soft illuminative sheet 1 produce different colors of light. In combination with the control circuit, the light is flashed or arranged in figured pattern so as to achieve better warning effect. This is a further embodiment of the present invention.

It should be noted that the above description and accompanying drawings are only used to illustrated some embodiments of the present invention, not intended to limit the scope thereof. Any modification of the embodiments should fall within the scope of the present invention.

What is claimed is:

1. A safety warning and winker light for vehicle comprising
a soft illuminative sheet and a high-adhesive sticker;
said soft illuminative sheet having a plurality of illuminator that is connected with a power of a car by a lead wire so as to make said soft illuminative sheet radiate;
said high-adhesive sticker is disposed on the bottom side of said soft illuminative sheet for fixing said soft illuminative sheet on front windscreens of cars.

2. The safety warning and winker light for vehicle as claimed in claim 1, wherein said soft illuminative sheet having two transparent sheets with said illuminators installed therebetween.

3. The safety warning and winker light for vehicle as claimed in claim 1, wherein said illuminators are light-emitting diode, diode chips or bulbs.

4. The safety warning and winker light for vehicle as claimed in claim 1, wherein said soft illuminative sheet is a cold light plate.

5. The safety warning and winker light for vehicle as claimed in claim 1, wherein said soft illuminative sheet having a plurality of light-guide bar with said illuminator disposed on one end or two ends thereof.
